(19) United States
(12) Patent Application Publication
(10) Pub. No.: US 2025/0182065 A1
(43) Pub. Date: Jun. 5, 2025

(54) ROAD MAINTENANCE AND MANAGEMENT PLANNING SUPPORT SYSTEM

(71) Applicant: Central Nippon Expressway Company Limited, Nagoya-shi (JP)

(72) Inventors: Atsushi ONISHI, Nagoya-shi (JP); Toshiki SAKAKIBARA, Nagoya-shi (JP); Koshiro MORI, Nagoya-shi (JP)

(21) Appl. No.: 18/953,893

(22) Filed: Nov. 20, 2024

(30) Foreign Application Priority Data
Dec. 4, 2023 (JP) 2023-204353

(51) Int. Cl. G06Q 10/20; G06Q 10/04

(52) U.S. Cl. CPC G06Q 10/20; G06Q 10/04

(57) ABSTRACT

A road to be repaired is divided into a plurality of segments, for each segment, the priority obtained based on the specification information and according to the road standard of the road to be repaired, the priority obtained by taking into account a number of segments of same repair type in predetermined area, and the priority obtained by taking into account a number of points requiring repair of the same type in the same route are multiplied by the post-repair condition score of the segment to calculate the post-repair weighted condition score. A discrete variables maximizing total sum of values of each segment is calculated, wherein the values of each segment obtained by adding value obtained by multiplying the discrete variable taking either 1 or 0 by the post-repair weighted condition score and value obtained by multiplying difference of 1 and the discrete variable by the condition score. Then, on the basis of the discrete variables, it is determined whether or not repair is necessary for each segment.

### TECHNICAL FIELD

The present invention relates to a road maintenance and management planning support system using mathematical optimization.

### BACKGROUND OF THE INVENTION

Various methods have been proposed to support the planning of maintenance and management for buildings using mathematical optimization.

For example, Patent Publication No. 7297165 discloses a method of determining an optimum repair scenario wherein a network model is formed by assigning a condition rate at an arbitrary time point as a node and allocating a repair cost or a cost in the case of non-repair to an edge on a per-structure basis.

Further, JP 2019-71017 A discloses a method of determining an optimum repair timing for an arbitrary repair point on a road based on past deterioration status, repair history, traffic volume, and the like by using an autoregressive model or the like.

### PRIOR ART DOCUMENTS

### Patent Document

[Patent Document 1] Japan Patent publication No. 7297165
[Patent Document 2] JP 2019-71017 A

### SUMMARY OF THE INVENTION

### Problem to be Solved by the Invention

However, it has been difficult to apply the conventional method of supporting the maintenance and management planning for structures such as bridges to items such as pavement repair and weeding managed in a wide range of area.

On the other hand, the conventional method for supporting the maintenance and management planning for the road requires historical information such as traffic volume, maintenance history, and damage history, and it is difficult to apply the method to a road wherein the historical information is not stored in a database and is not maintained.

Therefore, an object of the present invention is to provide road maintenance and management planning support system that can be applied to planning road maintenance and management using mathematical optimization for items managed in a wide range of area even in the case where history information is not stored in a database and is not maintained.

### Means for Solving the Problems

A road maintenance and management planning support system according to the present invention comprises dividing a road to be repaired into a plurality of segments, usage of specification information of the road to be repaired and condition score indicating condition of the road to be repaired, calculation of post-repair weighted condition scores for each segment by multiplying a priority obtained based on the specification information and according to a road standard of the road to be repaired, a priority obtained by taking into account a number of segments of same repair type in predetermined area, and a priority obtained by taking into account a number of points requiring repair of the same type in the same route by a post-repair condition score of the segment, and, calculation of discrete variables maximizing total sum of values of each segment, wherein the values of each segment obtained by adding value obtained by multiplying the discrete variable taking either 1 or 0 by the post-repair weighted condition score and value obtained by multiplying difference of 1 and the discrete variable by the condition score.

The discrete variables may be calculated within a range where total repair cost being total sum of cost of each segment becomes equal to or less than the budget upper limit, the cost of each segment is obtained by multiplying repair cost by the discrete variable.

Repair scheduled for the each segment may be classified into classes according to the condition score, and, small-scale implementation discrete variables may be calculated such that total sum of costs of each segment becomes more than cost allocated to small-scale repair of the total repair cost, the cost of each segment is obtained by multiplying the small-scale implementation discrete variable taking 1 in case where the small-scale repair in the classes is performed and taking 0 in case where the small-scale repair in the classes is not performed, and the discrete variables by the total repair cost.

Repair scheduled for the each segment may be classified into classes according to the condition score, and, large-scale implementation discrete variables may be calculated such that total sum of cost of each segment becomes more than cost allocated to large-scale repair of the total repair cost, the cost of each segment is obtained by multiplying the large-scale implementation discrete variable taking 1 in case where the large-scale repair in the classes is performed and taking 0 in case where the large-scale repair in the classes is not performed, and the discrete variables by the total repair cost.

### Effect of the Invention

The road maintenance and management planning support system according to the present invention uses the specification information of the road to be repaired and the condition score indicating the condition of the road to be repaired, and thus can be applied to a case where history information is not stored in a database and is not maintained. Further, it divides the road to be repaired into a plurality of segments, and uses the post-repair weighted condition scores for each segment calculated by multiplying a priority obtained based on the specification information and according to a road standard of the road to be repaired, a priority obtained by taking into account a number of segments of same repair type in predetermined area, and a priority obtained by taking into account a number of points requiring repair of the same type in the same route by a post-repair condition score of the segment, and thus can also be applied to the items managed in a wide range of area.

### BRIEF DESCRIPTION OF THE DRAWINGS

FIG. 1 It is a block diagram showing an outline of an embodiment of the road maintenance and management planning support system according to the present invention.

FIG. 2 It is a drawing showing the correlation of the condition score to 7-level evaluation, repair type, repair unit price, and post-repair score.

FIG. 3 It is a view showing the status of the road to be repaired shown by the 7-level evaluation.

FIG. 4 It is a view showing a status of a road to be repaired after repairing by a pavement repair plan in the first year.

FIG. 5 It is a view showing a status of a road to be repaired after repairing by a pavement repair plan in the second year.

FIG. 6 It is a diagram showing a deterioration curve used for estimating a condition score of a part to be repaired in the first year after the repairing.

### MODE FOR CARRYING OUT THE INVENTION

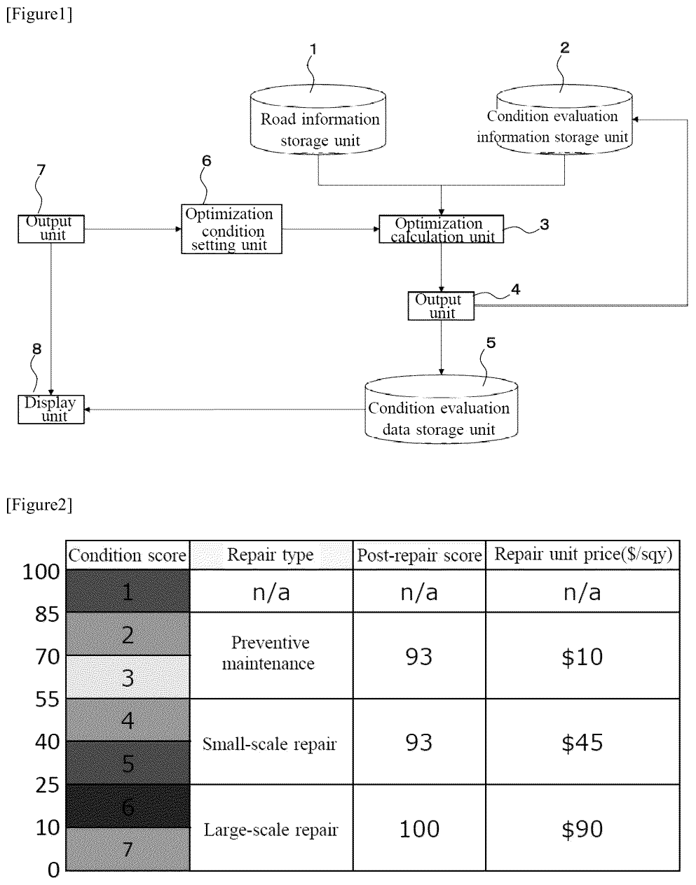

An embodiment of a road maintenance and management planning support system according to the present invention will be described with reference to FIG. 1.

The road maintenance and management planning support system of this embodiment comprises a road information storage unit 1, a condition evaluation information storage unit 2, an optimization calculation unit 3, an output unit 4, and a condition evaluation data storage unit 5.

The road information storage unit 1 stores specification information of the road to be repaired. The specification information is information mainly including information related to the design of the shape, structure, and the like of the road and information related to the construction work. History information indicating the usage status after opening, such as the traffic volume, is not essential, but may be stored as reference information.

The condition evaluation information storage unit 2 stores, for each segment formed by dividing a road to be repaired, a condition score at the time of drafting a road maintenance management plan of the road to be repaired and its ancillary equipment, and their post-repair condition score expected by performing repairs.

An optimization condition setting unit 6 that sets the conditions of the calculation processing is connected to the optimization calculation unit 3. The optimization condition setting unit 6 receives the conditions of the arithmetic processing via the input unit 7, and the optimization calculation unit 3 uses the data stored in the road information storage unit 1 and the condition evaluation information storage unit 2, and performs arithmetic processing for determining whether or not the repair execution for each segment according to the conditions set by the optimization condition setting unit 6 is necessary.

In the arithmetic processing executed by the optimization calculation unit 3, first, for each segment, the priority obtained based on the specification information and according to the road standard of the road to be repaired (hereinafter, referred to as “road standard priority”), the priority obtained by taking into account a number of segments of same repair type in predetermined area (hereinafter, referred to as “vicinity priority”), and the priority obtained by taking into account a number of points requiring repair of the same type in the same route (hereinafter, referred to as “route priority”) are multiplied by the post-repair condition score of the segment to calculate the post-repair weighted condition score. In this embodiment, the definition formula of the post-repair weighted condition score is shown below.

[FORMULA 1]

$${r}_{i} = {\underbrace{{w}_{i}}}_{road standard priority} \times {\underbrace{( 1 + \frac{{n}_{i}}{max ( {n}_{{∀}_{i}} )} )}}_{vicinity priority} \times {\underbrace{( 1 + \frac{{k}_{i}}{max ( {k}_{{∀}_{i}} )} )}}_{route priority} \times {v}_{i} \qquad ( 1 )$$

wᵢ Weight score of the segment according to the road standard
rᵢ Post-repair weighted condition score of the segment
nᵢ Number of segments of the same repair type within the set range from the segment
kᵢ Number of segments of the same repair type within the same route as the segment
vᵢ Post-repair condition score of the segment
max(n_{∀}_{ᵢ}) Maximum number of segments of the same repair type within the set range from each segment
max(k_{∀}_{ᵢ}) Maximum number of segments of the same repair type in each route

Next, a discrete variables maximizing total sum of values of each segment is calculated, wherein the values of each segment obtained by adding value obtained by multiplying the discrete variable taking either 1 or 0 by the post-repair weighted condition score and value obtained by multiplying difference of 1 and the discrete variable by the condition score. Then, on the basis of the discrete variables, it is determined whether or not repair is necessary for each segment. That is, in the case where the discrete variable is 1, repair is necessary, and in the case where the discrete variable is 0, repair is unnecessary. The formula for calculating the discrete variables in this embodiment is shown below.

[FORMULA 2]

$${max}_{x} \frac{1}{n ( {x}_{i} )} {\sum }_{i ∈ A} ( {r}_{i} {x}_{i} + {s}_{i} ( 1 - {x}_{i} ) ) \qquad ( 2 )$$

A Subject to maintenance and management plan
xᵢ Discrete variables (Repair: 1/Non-Repair: 0)
rᵢ Post-repair weighted condition score of the segment
sᵢ Condition score of the segment
n(xᵢ) Total number of discrete variables

Further, in this embodiment, the budget upper limit is taken into account as the optimization condition. The formula for calculating a discrete variable satisfying the budget upper limit is shown below.

[FORMULA 3]

$${\sum }_{i ∈ A} {c}_{i} {x}_{i} \leq {B}_{max} \qquad ( 3 )$$

A Subject to maintenance and management plan
xᵢ Discrete variables (Repair: 1/Non-Repair: 0)
cᵢ Repair cost of the segment
Bₘₐₓ Upper limit of the maintenance budget
   Note that the repair cost c and the upper limit Bmax of the maintenance budget for each segment is input to the optimization condition setting unit 6 via the input unit 7.

Further, in this embodiment, the repair scheduled for each segment is classified into preventive maintenance, small-scale repair, and large-scale repair according to the condition score S, and as an optimization condition, the budget allocated to the small-scale repair and the budget allocated to the large-scale repair are considered.

The formula for calculating small-scale implementation discrete variables that meet the budget allocated for small-scale repairs is shown below.

[FORMULA 4]

$${\sum }_{i ∈ A} {m}_{i} {c}_{i} {x}_{i} \geq {B}_{minor} {\sum }_{i ∈ A} {c}_{i} {x}_{i} \qquad ( 4 )$$

A Subject to maintenance and management plan
xᵢ Discrete variables (Repair: 1/Non-Repair: 0)
mᵢ Small-scale implementation discrete variables (Small-scale repair: 1/Non-Repair: 0)
cᵢ Repair cost of the segment
Bₘᵢₙₒᵣ Budget allocation for small-scale repairs (%)
   The calculation target by Formula (4) is a small-scale implemented discrete variable mi, and values satisfying Formula (2) and (3) are input to the discrete variable xi. Further, the repair cost ci for each segment and the budget allocation rate Bminor for the small-scale repair are input to the optimization condition setting unit 6 via the input unit 7.

Next, the formula for calculating large-scale implementation discrete variables that meet the budget allocated for large-scale repairs is shown below.

[FORMULA 5]

$${\sum }_{i ∈ A} {M}_{i} {c}_{i} {x}_{i} \geq {B}_{major} {\sum }_{i ∈ A} {c}_{i} {x}_{i} \qquad ( 5 )$$

A Subject to maintenance and management plan
xᵢ Discrete variables (Repair: 1/Non-Repair: 0)
Mᵢ Large-scale implementation discrete variables (Large-scale repair: 1/Non-Repair: 0)
cᵢ Repair cost of the segment
Bₘₐⱼₒᵣ Budget allocation for large-scale repairs (%)
   The calculation target by Formula (5) is a large-scale implemented discrete variable Mi, and values satisfying Formula (2) and (3) are input to the discrete variable xi. Further, the repair cost ci for each segment and the budget allocation rate Bmajor for the large-scale repair are input to the optimization condition setting unit 6 via the input unit 7.

The repair necessity determination result for each segment obtained by the arithmetic processing of the optimization calculation unit 3 is output to the output unit 4 and stored in the condition evaluation data storage unit 5. In addition, for the segments that are required to be repaired, the condition score after repairing is substituted, and the condition score at the time point that is the target of the next repairing plan is estimated, and the estimated value is stored in the condition evaluation information storage unit 2. For example, when the repair is performed every year, an estimated value after one year of the repair is stored. Therefore, the calculation regarding the repair time that arrives after the repair according to the repair plan is performed can also be performed continuously by using the estimated value.

The estimation of the condition score can be performed using, for example, a deterioration curve. However, the estimation method is not limited, and other known estimation methods may be adopted.

The repair necessity determination result for each segment stored in the condition evaluation data storage unit 5 is displayed on the display unit 8 together with the setting conditions input to the optimization condition setting unit 6 via the input unit 7.

### Examples

For a road passing through small cities in northern Texas, U.S.A., the part over the total extension 53.5 km was divided into 5348 segments (every 10 m), and the necessity of repair was decided for each segment, and pavement repair planning was decided.

As the road information, the following items were used in the arithmetic processing for determining whether repair is necessary or not.
Pavement type asphalt/concrete
Residential street width 21 Feet
Second-class trunk road width 24 Feet
Third-class trunk road width 24 Feet

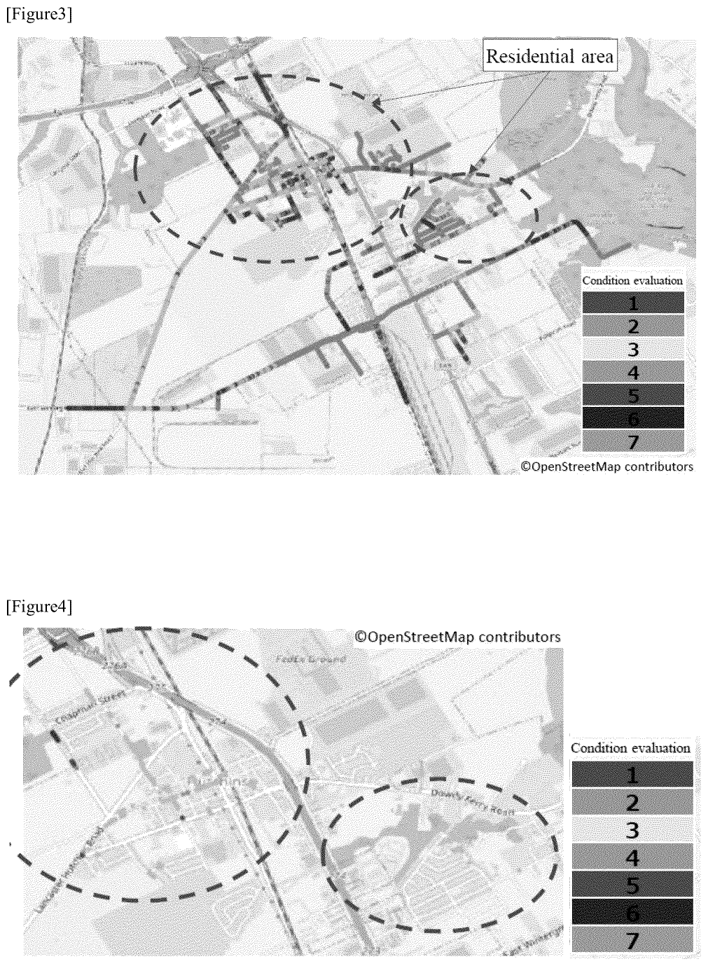

Condition was assessed at a score of 0 to 100 per segment. In addition, the 7-level evaluation is summarized as follows: 0-10:7; 11-25:6; 26-40:5; 41-55:4; 56-70:3; 71-85:2; and 86-100:1. The repair type, repair unit price, and post-repair score were set for each level. FIG. 2 shows the correlation between the condition score and the 7-level evaluation, the repair type, the repair unit price, and the post-repair score, and FIG. 3 shows the status of the road to be repaired indicated by the 7-level evaluation.

In order to calculate the post-repair weighted condition scores, the weights according to the road standards were set as follows, with the higher the numerical value, the higher the priority.
Residential Street 3
Second-class Trunk Road 1
Third-class Trunk Road 1

In addition, 150 feet is the scope of searching for segments of the same repair type for calculation of post-repair weighted condition scores.

In addition, as an optimization condition, the budget setting is as follows.
Budgetary limit 300000 USD/Year
Small-scale repair allocation budget 20%
Large-scale repair allocation budget 30%

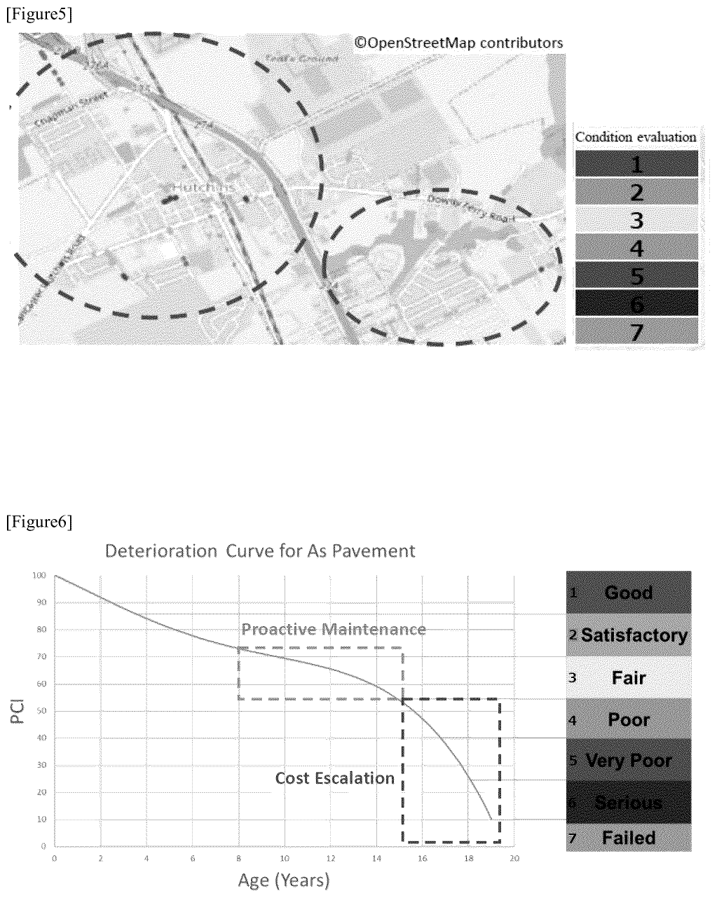

FIG. 4 shows the status of the roads to be repaired after the repairs by the pavement repair plan in the first year, and FIG. 5 shows the status of the roads to be repaired after repairing by the pavement repair plan in the second year. FIG. 6 shows the deterioration curve used for estimating the condition score of the part to be repaired in the first year after the repairing (timing when the pavement repairing plan of the second year is decided). In FIG. 4 and FIG. 5, the part that belongs to the level 1 of the 7-level evaluation by repair is not colored.

In the optimization condition set in this embodiment, it was confirmed that a point where the same segment of the repair type is concentrated is selected as the repair target with priority given to the residential street.

### DESCRIPTION OF SYMBOLS

1 Road information storage unit
2 Condition evaluation information storage unit
3 Optimization calculation unit
4 Output unit
5 Condition evaluation data storage unit
6 Optimization condition setting unit
7 Input unit
8 Display unit

What is claimed is:

1. Road maintenance and management planning support system comprising;
dividing a road to be repaired into a plurality of segments,
usage of specification information of the road to be repaired and condition score indicating condition of the road to be repaired,
calculation of post-repair weighted condition scores for each segment by multiplying a priority obtained based on the specification information and according to a road standard of the road to be repaired, a priority obtained by taking into account a number of segments of same repair type in predetermined area, and a priority obtained by taking into account a number of points requiring repair of the same type in the same route by a post-repair condition score of the segment,
and, calculation of discrete variables maximizing total sum of values of each segment, wherein the values of each segment obtained by adding value obtained by multiplying the discrete variable taking either 1 or 0 by the post-repair weighted condition score and value obtained by multiplying difference of 1 and the discrete variable by the condition score.

2. The road maintenance and management planning support system according to claim 1, wherein the discrete variables are calculated within a range where total repair cost being total sum of cost of each segment becomes equal to or less than the budget upper limit, the cost of each segment is obtained by multiplying repair cost by the discrete variable.

3. The road maintenance and management planning support system according to claim 2, wherein repair scheduled for the each segment is classified into classes according to the condition score,
and, small-scale implementation discrete variables are calculated such that total sum of costs of each segment becomes more than cost allocated to small-scale repair of the total repair cost, the cost of each segment is obtained by multiplying the small-scale implementation discrete variable taking 1 in case where the small-scale repair in the classes is performed and taking 0 in case where the small-scale repair in the classes is not performed, and the discrete variables by the total repair cost.

4. The road maintenance and management planning support system according to claim 2, wherein repair scheduled for the each segment is classified into classes according to the condition score,
and, large-scale implementation discrete variables are calculated such that total sum of cost of each segment becomes more than cost allocated to large-scale repair of the total repair cost, the cost of each segment is obtained by multiplying the large-scale implementation discrete variable taking 1 in case where the large-scale repair in the classes is performed and taking 0 in case where the large-scale repair in the classes is not performed, and the discrete variables by the total repair cost.
